(19) United States
(12) Patent Application Publication
(10) Pub. No.: US 2005/0163906 A1
(43) Pub. Date: Jul. 28, 2005

(54) Coconut beverage and method of producing the same

(76) Inventor: Guillermo Silva, North Miami, FL (US)

Correspondence Address: Sanchelima and Associates, P. A.;Jesus Sanchelima, Esq., 235 S.W. Le Jeune Rd., Miami, FL, 33134, US

(21) Appl. No.: 10/765,193

(22) Filed: Jan. 28, 2004

(51) Int. Cl. C12C 1/00

(52) U.S. Cl. 426/590

(57) ABSTRACT

A rich creamy coconut beverage that resembles the flavor of a coconut beverage developed from fresh raw ingredients. The coconut beverage is produced having the similar texture, consistency, taste, and appearance of mixing natural liquid endosperm with the jelly-like meat of an immature coconut recently picked from a coconut palm tree. A method of producing the coconut beverage is also disclosed.

### II. BACKGROUND OF THE INVENTION

1. Field of the Invention

The present invention relates to fruit beverages, and more particularly, to a coconut beverage and the process to make it.

2. Description of the Related Art

A coconut beverage is a traditional tropical drink based on young coconut meat, and coconut water also defined as liquid endosperm. Homemade preparation is extremely simple, but would represent a challenge to replicate it in an area not having coconut palm trees. The complexity is based on the fact that the coconut beverage must be produced when the coconut fruit is in its early stages of maturation, when the fruit has been just harvested from the coconut palm tree. This complexity creates a major limitation on its retail sale in places where the raw material is not available, as well as the difficulties in placing and distributing the fruits when taking into consideration weight and volume. In addition, the shelf life of a coconut in its early stages is extremely short. Yet other limitations are those imposed by some countries including the US Department of Agriculture and US Customs that prevent the importation of coconuts with outer husks. Specifically, the Department of Agriculture from the US Government (USDA) and the US Animal and Plant Health Inspection Service (APHIS) does not allow the importation of coconuts with outer husks, because of the fear of spread of diseases.

The coconut originates from certain areas of the world having a wet tropical environment such as: the Indo Malayan region, Southeast Asian countries, India, Sri-Lanka, Pacific Islands, Thailand, East and West Africa, and Central & South American Countries.

According with the Horticultural Maturities Indices: Young coconuts are harvested 6 to 9 months after flowering (Consignado et al., 1976; Srivichai, 1997), as the nut approaches full size and the skin is still green.

Immature, de-husked coconuts are about 10 cm (4 inches) in diameter and weigh about 500 g (1.1 lb.): 100 g (3.5 oz) endosperm, 120 g (4.2 oz) shell and 250 g (8.8 oz) water. At maturity, the coconut is 10 to 12 months old. At maturity the skin begins to change from green to yellow and then brown, and the stem is entirely brown. The solid endosperm starts at 6 to 9 months. The cost of refrigeration shipments for de-husk coconuts from coconut growing localities to the USA is so great that such coconuts cannot be used economically.

Mature coconuts with outer husks can be kept at ambient conditions for 3 to 5 month before the liquid endosperm has evaporated. Typically, the outer shell cracks because desiccation or sprouting has occurred. Without refrigeration, fresh coconuts deteriorate readily and quickly, becoming moldy and sour. Storage at temperatures between 0 to 1.5° C. (32 to 35° F.) and humidity of 75 to 85% is possible for up to 60 days for mature. De-husked coconuts in temperatures between 13 to 160° C. (55 to 60° F.) and humidity of 80 to 85% can last two weeks or less. Low humidity and high temperatures should be avoided. Young coconuts are normally held at temperatures between 3 to 6° C. (37 to 43° F.) with humidity levels between 90 to 95%. Moisture loss causes a loss of water in the coconut that can be reduced by humidity control, film wrapping or waxing.

Each liter of coconut water contains approximately 25.7 g sugar, 5.3 g protein and 4.7 g of minerals. The potassium content of coconut water is relatively high at 36.4 to 49.0 mEq/liter (Milli-equivalents per liter) while the sodium content is from 2.5 to 5 mEq/liter. Coconut water is extremely perishable because it contains sugars, proteins, amino acid, oils, minerals, vitamins and phytohermones that conducive to microbial growth. By removing the water, the fruit is stabilized.

In the USA and specifically South Florida, the coconut palm tree produces coconuts. According to the United States National Arboretum (USDA) the hardiness zone is from 10 a/b to 11. The 10 a: Average annual minimum temperature is 35 to 40° C. And the 10 b: Average annual minimum temperature is +40° C. for South Florida. The coconut palm is not native to North America.

In South Florida, the coconut palm tree starts producing fruit within 6 to 10 years after a coconut seed germinates, and it reaches full production at 15 to 20 years of age. The coconut palm tree continues to bear coconuts until it is about 80 years old with an annual production of 50 to 200 fruits per palm, depending on cultivating techniques and climate. The coconuts require about a year to develop and are generally produced regularly throughout the year.

Propagation is entirely from seeds that are ready for planting if they produce an audible “sloshing” sound when shaken. The coconuts are placed on their sides and buried to about one-half their thickness with sand or mulch. They may be planted in closely spaced rows in well-drained seedbeds or they may be planted directly into large pots. Germination is best under high temperatures between 90 to 100 degrees F. Upon germination, the shoot and root emerge through the side or one end of the coconut. Young palms, about 6 months old, can be transplanted directly into the field or be grown in pots in a nursery for a few more years.

The coconut palm tree is typically found along tropical, sandy shorelines since it can tolerate brackish soils and salt spray. However, salt is not required for the growth of healthy plants and they can be successfully grown well inland. Coconut palms grow well in a wide range of soil types, provided they are well drained, and a wide pH range, from 5.0 to 8.0. Successful growth requires a minimum average temperature of 72 degrees F. and an annual rainfall of 30 to 50 inches or more. The trees may be injured by cold when the temperature falls below 32 degrees F. (0 degrees C.). They require full sunlight and are tolerant to wind and temporary flooding.

Environmental stresses do of course affect the coconut palm trees. Coconut palm trees are tolerant of dry soil conditions. However, for optimum fruit production and quality, regular irrigation is recommended during dry periods. Coconut palm trees are tolerant of waterlogged or flooded soil conditions for a few days. However, trees may decline and die when exposed to prolonged flooding or waterlogged soils. Coconut palm trees are injured by temperatures below 32 degrees F. (0 degrees C.), with desiccated foliage as the primary symptom. More severe freezes can also result in death of the bud. Coconut palm trees are not suitable for areas that regularly experience freezing temperatures. Coconut palm trees are quite tolerant of windy sites and generally survive hurricane force winds. The most common damage from hurricane winds is loss of leaves and toppling over. If uprooted palms are righted promptly and adequately watered, survival of these palms is usually quite good.

Coconut palm trees are tolerant of saline water and soils, as well as salt spray. Lightning occasionally strikes tall coconut palm trees. Symptoms of lightning strikes include sudden collapse of the canopy, trunk splitting, and bleeding.

Lethal yellowing is the most damaging disease of coconut palm trees in Florida. Since it was discovered in Key West over 200 years ago, it has crept northward, killing hundreds of thousands of palm tree trees and endangering virtually all of the tall coconut palms in Florida. A tiny organism called a phytoplasma that is visible only with the aid of an electron microscope causes lethal yellowing. Early symptoms are premature dropping of coconuts and blackening of flower stalks. The leaves then turn yellow, beginning with the lower ones and progressing to the crown that dies and eventually topples from the tree. The tree usually dies within 6 months after exhibiting the first symptoms.

The limitations mentioned above could be overcome by substituting the raw materials with acceptable processed ingredients to therefore provide a coconut beverage in areas where the coconut palm trees do not grow. Many fruit beverages have been designed in the past. None of them, however, include a unique combination of ingredients that when combined with a particular process, produce a creamy cold coconut beverage.

Applicant believes that the closest reference corresponds to U.S. Pat. No. 4,680,179 issued to Lidman for Coconut fruit(s) flavored brandy on Jul. 14, 1987. However, it differs from the present invention because Lidman teaches a process of improving the production of coconut brandy, which results in a smoother, mellower distilled spirit than brandy produced by current methods. Specifically, the process replaces sulphur with calamansi juice and jackfruit meat and coconut juice for boiled spring water, adds yeast, ferments, strains and distills this mixture, producing a clear, colorless, fruity improved coconut brandy.

Other patents describing the closest subject matter provide for a number of more or less complicated features that fail to solve the problem in an efficient and economical way. None of these patents suggest the novel features of the present invention.

### III. SUMMARY OF THE INVENTION

A rich creamy coconut beverage comprising water, a contained and preserved liquid base developed from mixing water, sugar and a coconut cream powder derivative of natural coconut that is processed from natural coconut milk through a spray drying process, sugar, ice, and contained and preserved young coconut meat originating from natural coconut at its immature stage.

The rich creamy coconut beverage resembling in texture, consistency, taste, and appearance of mixing natural coconut liquid endosperm with jelly-like meat of an immature natural coconut recently picked from a coconut palm tree.

The spray drying process is a unit operation where a pumpable liquid feed is finely dispersed or atomized to form droplets that are sprayed into a heated air chamber and facilitate dehydratacion of the droplets. Thus, forming powder particles that are conveyed to a cyclone where the coconut cream powder is collected.

The coconut cream powder derivative comprises natural coconut and a starch hydrolysis product, which may be maltodextrin or a material having similar characteristics.

The young coconut meat contains mainly water and jelly-like meat, which are collected, bleached and contained with preservatives.

The rich creamy coconut beverage may also have vanilla extract for additional flavor.

A method to develop a coconut beverage is also disclosed, comprising:
A) pouring approximately 8 ounces of cold water into a blender;
B) pouring approximately 4 ounces of a contained and preserved liquid base developed from mixing water, sugar and a coconut cream powder derivative of natural coconut into the blender;
C) pouring approximately 1.75 ounces of sugar into the blender;
D) blending at a low speed for about one minute ingredients in A-C above;
E) adding approximately 14 ounces of ice into the blender;
F) adding approximately 3.53 ounces of contained and preserved young coconut meat originating from the natural coconut at its immature stage into the blender;
G) adding approximately 0.0625 ounces of vanilla essence into the blender;
H) blending at a high speed for about one minute ingredients in A-C and E-G above until smooth; and

I) serving into a container for consumption.

It is therefore one of the main objects of the present invention to provide a rich coconut beverage that matches the flavor of a coconut beverage developed from fresh raw ingredients, without using fresh raw ingredients.

It is another object of this invention to provide a creamy coconut beverage that matches the consistency of a coconut beverage developed from fresh raw ingredients, without using fresh raw ingredients.

It is another object of this invention to provide a creamy coconut beverage developed from a derivative of real coconut that goes from coconut milk to coconut cream powder through a delicate process called spray drying and preserved natural young coconut meat.

It is still another object of the present invention to provide a coconut beverage that has a superior coconut taste over typical coconut drinks.

It is yet another object of this invention to provide such a beverage that is inexpensive to manufacture and maintain while retaining its superior taste in those areas not having native coconut palm trees.

Further objects of the invention will be brought out in the following part of the specification, wherein detailed description is for the purpose of fully disclosing the invention without placing limitations thereon.

### IV. DETAILED DESCRIPTION OF THE PREFERRED EMBODIMENT

The present invention is a new, feasible, simple, and practical way to produce coconut beverages at the place of consumption while meeting demand, in an economical way and in accordance with national laws in an area not having immature coconuts.

The instant invention comprises two primary ingredients, defined as Product A and Product B that are blended together to produce a smoothie type beverage, defined as the coconut beverage.

To produce the coconut beverage at an retail level, it is important to obtain a liquid base that tastes and smells like coconut and that serves as the base in its preparation. The liquid base is developed from the mixture of water, sugar, and a coconut cream powder defined as Product A. Coconut cream powder may also be defined as desiccated coconut and is a source material for this coconut beverage. Desiccated coconut is customarily used as a food and is produced in the form of strips, tapes, chips, shreds, threads, or grated granules.

Product A is a derivative of real coconut that goes from coconut milk, or a similar source material, to coconut cream powder, or a similar source material, through a delicate process called spray drying. Spray drying is a unit operation where a pumpable liquid feed is finely dispersed or atomized to form droplets, which are sprayed into a heated air chamber. The process facilitates the dehydratacion of the feed droplets, thus forming the powder particles. The powder is then conveyed to a highly efficient cyclone where product is collected in a container while the spent drying air is exhausted to the atmosphere.

In the preferred embodiment, product A comprises approximately 80% natural coconut and approximately 20% maltodextrin. Maltodextrin is a derivative of real coconut that is obtained from coconut milk that is spray-dried to develop a coconut cream powder. Maltodextrin is defined as a starch hydrolysis product generally having a Dextrose Equivalent (DE) between 5 and 20 usually produced by the action of an amylase enzyme on gelatinized starch. Maltodextrin contains a range of non-sweet polysaccharides with a distribution of molecular weights where the anhydroglucose units are linked predominantly by 1,4 bonds. It is noted that maltodextrin may be replaced by other matter having similar properties and characteristics. This liquid base can then be maintained in a refrigerated mixing beverage dispenser.

Product B is natural young coconut meat. Product B is obtained from the coconut at its immature stage where the fruit contains mainly water and a jelly-like meat instead of a hard white flesh found in a mature coconut. Young coconuts are harvested six to nine months after flowering, as the nut of the coconut approaches full size and the skin of the coconut is still green. In addition, the short stem on top of each individual coconut that originally held male flowers are now a greenish and brownish color. The jelly-like meat is canned. When the fruit has been harvested from the palm tree the coconut is opened and the jelly-like meat is collected, bleached and canned with citric acid (approximately 0.1%) and sodium metabisulfite (approximately 0.02%), with a concentration of 10-40 ppm maximum to control the pH. It is noted that the citric acid and sodium metabisulfite may be replaced by other matter having similar properties and characteristics. In this canned form with preservatives, the jelly-like meat can be handled while avoiding the natural limitations of the immature coconut such as, but limited to, preservation for extended shelf life. In addition, the pH is used for government importation regulations. Other pH adjustors can be used.

A method to develop the coconut beverage described above is also disclosed, comprising the steps of:
A) pouring approximately 8 ounces of cold water into a blender;
B) pouring approximately 4 ounces of a contained and preserved liquid base developed from mixing water, sugar and a coconut cream powder derivative of natural coconut into said blender;
C) pouring approximately 1.75 ounces of sugar into said blender;
D) blending at a low speed for about one minute ingredients in A-C above;
E) adding approximately 14 ounces of ice into said blender;
F) adding approximately 3.53 ounces of contained and preserved young coconut meat originating from said natural coconut at its immature stage into said blender;
G) adding approximately 0.0625 ounces of vanilla essence into said blender;
H) blending at a high speed for about one minute ingredients in A-C and E-G above until smooth; and
I) serving into a container for consumption.

With the measurements defined above, approximately 24 ounces of coconut beverage is produced having the same texture, consistency, taste, and appearance of mixing the natural liquid endosperm with the jelly-like meat endosperm of an immature coconut recently picked from a coconut palm tree. Products A and B readily serve as a reliable and satisfactory source of “raw material” for utilization in the production of the freshly prepared coconut beverage. It is noted that other fruits may be added for different tastes.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

1. A rich creamy coconut beverage comprising:
A) water;
B) a contained and preserved liquid base developed from mixing water, sugar and a coconut cream powder derivative of natural coconut that is processed from natural coconut milk through a spray drying process;
C) sugar;
D) ice; and
E) contained and preserved young coconut meat originating from said natural coconut at its immature stage.

2. The rich creamy coconut beverage set forth in claim 1, further characterized in resembling texture, consistency, taste, and appearance of mixing natural coconut liquid endosperm with jelly-like meat of an immature said natural coconut recently picked from a coconut palm tree.

3. The rich creamy coconut beverage set forth in claim 2, further characterized in that said spray drying process is a unit operation where a pumpable liquid feed is finely dispersed or atomized to form droplets that are sprayed into a heated air chamber and facilitate dehydratacion of said droplets, thus forming powder particles, said powder particles are conveyed to a cyclone where said coconut cream powder is collected.

4. The rich creamy coconut beverage set forth in claim 3, further characterized in that said coconut cream powder derivative comprises said natural coconut and a starch hydrolysis product.

5. The rich creamy coconut beverage set forth in claim 4, further characterized in that said starch hydrolysis product is maltodextrin.

6. The rich creamy coconut beverage set forth in claim 5, further characterized in that said young coconut meat contains mainly water and said jelly-like meat which are collected, bleached and contained with preservatives.

7. The rich creamy coconut beverage set forth in claim 6, further characterized in that said rich creamy coconut beverage has vanilla extract.

8. A method to develop a coconut beverage, comprising:
A) pouring approximately 8 ounces of cold water into a blender;
B) pouring approximately 4 ounces of a contained and preserved liquid base developed from mixing water, sugar and a coconut cream powder derivative of natural coconut into said blender;
C) pouring approximately 1.75 ounces of sugar into said blender;
D) blending at a low speed for about one minute ingredients in A-C above;
E) adding approximately 14 ounces of ice into said blender;
F) adding approximately 3.53 ounces of contained and preserved young coconut meat originating from said natural coconut at its immature stage into said blender;
G) adding approximately 0.0625 ounces of vanilla essence into said blender;
H) blending at a high speed for about one minute ingredients in A-C and E-G above until smooth; and
I) serving into a container for consumption.
